(19) United States
(12) Patent Application Publication
(10) Pub. No.: US 2024/0198291 A1
(43) Pub. Date: Jun. 20, 2024

(54) SYSTEMS AND METHODS FOR RAPID FLUSHING OF A MEMBRANE-BASED SYSTEM

(71) Applicant: Massachusetts Institute of Technology, Cambridge, MA (US)

(72) Inventors: Quantum J. WEI, Cambridge, MA (US); Andrew T. BOUMA, Cambridge, MA (US); John H. LIENHARD, Lexington, KY (US)

(21) Appl. No.: 18/556,892

(22) PCT Filed: May 2, 2022
(86) PCT No.: PCT/US2022/027309

§ 371 Date: Oct. 24, 2023

Related U.S. Application Data
(60) Provisional application No. 63/182,761, filed on Apr. 30, 2021.

(51) Int. Cl. B01D 65/02; B01D 61/10

(52) U.S. Cl. CPC B01D 65/02; B01D 61/10; B01D 65/027; B01D 2311/14; B01D 2311/16; B01D 2313/243; B01D 2317/04; B01D 2321/04; B01D 2321/205; B01D 2321/2083

(57) ABSTRACT

Systems and methods for rapid flushing of a membrane-based fluid filtration system are disclosed herein. During flushing, a membrane of the system can be decoupled from other portions of the system and brine can be flushed from the membrane separate from the other portions of the system. In some embodiments, the membrane can be connected to a pump to form a flushing loop that is separate from the flushing loops of the main system to flow the flushing fluid therethrough. The flushing fluid through the membrane can be optimized and set based on a flow rate of the membrane to prevent damaging the membrane while minimizing flush time of the membrane relative to the flush time of the system.

### CROSS REFERENCE TO RELATED APPLICATION

The present disclosure claims priority to and the benefit of U.S. Provisional Application No. 63/182,761, entitled “Systems and Methods for Rapid Flushing of a Membrane-Based System,” filed on Apr. 30, 2021, the content of which is incorporated by reference herein in its entirety.

### FIELD

The present disclosure relates to systems and methods for improved flushing of a membrane-based fluid filtration system, and more particularly relates to improved systems and methods for rapidly flushing a batch reverse osmosis system in which a membrane can be a bottleneck for flushing the overall system.

### BACKGROUND

Due to growing water scarcity around the globe, expansion and diversification of the world's water supplies can be beneficial to humanity as it can save lives, prevent disease, and allow nations to thrive where previously unable. A lot of the water on Earth is contained in its oceans, seas, and saline aquifers, which due to their high salt content, needs to be purified prior to consumption or productive use by humans. Reverse osmosis (RO) is a state-of-the-art technology for water desalination, but tends to be costly due to high energy requirements and consumption. Batch RO has emerged as one of the most energy-efficient RO processes. Batch RO can make desalination more affordable and sustainable because it has been shown to save about one-fifth of the energy consumed by standard RO in seawater desalination. Batch RO also has the potential to reduce membrane scaling and membrane fouling, while being capable of variable operation that adapts to changing feedwater quality and is well-suited for pairing with renewable energy.

Use of batch RO has several shortcomings. For example, when run in a desalination process, water loss was observed during the flush and recharge phases, which results in an energy penalty in which only 2% energy savings is realized as compared to the RO process, rendering use of batch RO impractical. The energy loss can be attributed, for example, to the duration of the reset phases, or downtime, during which the system is depressurized, the driving force flips, and forward osmosis occurs, e.g., the freshwater that is produced by the RO process backflows into the system and mixes back with salty water.

Accordingly, improved systems and methods are needed for flushing systems to minimize the length of time of the reset phases of the RO process and to reduce the energy consumption thereof.

### SUMMARY

The present application is directed to systems and methods for rapid flushing of a membrane system. Reverse osmosis systems use fluid flowing through circulation tubing, or piping, for example, in high pressure systems, in conjunction with pressurized vessels and membranes for permeate production that accumulate concentrate with repeated use. In time-varying RO processes, system salinity increases over the course of a permeate production phase. When the desired salinity has been reached, which can possibly be dictated by constraints on system pressure salinity, the concentrate in the system can be flushed and replaced with fresh feed so that the cycle can repeat.

The systems and methods disclosed herein expedite the flushing of the components of the RO system. During a flush phase that is used to clean the system of concentrate, the system can be decoupled to a plurality of loops for ease of cleaning. The RO membranes support a maximum flowrate therethrough that is significantly smaller than the rest of the system. Cycle downtime can be reduced by decoupling the RO membranes from the rest of the system during flushing of the system. For example, in some embodiments, a first flush loop can include a pump and a membrane being connected by circulation tubing while a second flush loop can include a pump connected to the remainder of the system by circulation tubing. Each pump can be connected to a feed that supplies a flushing fluid to be pumped through each flush loop. Each pump can be set to a maximum supported flow rate by the components contained therein to flush the system to reduce downtime and minimize permeate backflow thereto.

One exemplary method of flushing a system includes decoupling one or more membranes from a circulation system and coupling the one or more membranes to a pump configured to deliver one or more fluids therefrom to form a first fluid path. The method further includes pumping fluid through the first fluid path to release concentrate formed in at least one of the one or more membranes or one or more components of the circulation system having the one or more membranes coupled to it and pumping fluid through a second fluid path of the circulation system to release concentrate formed in it, with the second fluid path not including the one or more membranes of the first fluid path.

In some embodiments, the method can further include optimizing a flow rate for pumping fluid through the second path such that pumping fluid through the first path and pumping fluid through the second path occurs at substantially the same time. The flow rate of fluid when pumping fluid through the second path can be greater than a flow rate of fluid when pumping fluid through the first path. In some embodiments, the flow rate of fluid when pumping fluid through the second path can be at least approximately in the range of about two times to about ten times greater than the flow rate of fluid when pumping fluid through the first path.

In some embodiments, the pumping fluid through the first path and the pumping fluid through the second path can occur substantially simultaneously. The pumping fluid through the second path and the pumping fluid through the first path can conclude at substantially the same time.

In some embodiments, the method can further include decoupling a first portion of the circulation system from the circulation system such that the second fluid path includes a first fluid sub-path and a second fluid sub-path. In at least some such embodiments, pumping fluid through the second fluid path can further include pumping fluid through the first fluid sub-path and through the second fluid sub-path. The method can further include decoupling a first membrane from the one or more membranes such that the first fluid path includes a first membrane fluid sub-path and a second membrane fluid sub-path. In at least some such embodiments, pumping fluid through the first fluid path can further include pumping fluid through the first membrane fluid sub-path and through the second membrane fluid sub-path. The first fluid path and the second fluid path can flow through common circulation tubing prior to branching into the first fluid path and the second fluid path.

A flushing pressure can be optimized to regulate backwash through the one or more membranes. For example, a flushing pressure can be optimized such that backwash is substantially eliminated through the one or more membranes. In some embodiments, a flushing pressure can be varied when performing at least one of the actions of pumping fluid through the first fluid path to release concentrate or pumping fluid through the second fluid path to release concentrate. In some embodiments, a flushing pressure can be optimized to continue producing permeate throughout at least one of the actions of pumping fluid through the first fluid path to release concentrate or pumping fluid through the second fluid path to release concentrate.

A temperature of the fluid can be optimized to at least one of regulate backwash, control membrane fouling, or control membrane scaling. In some embodiments, a composition of the fluid can be optimized to regulate backwash. Additionally, or alternatively, a composition of the fluid can be optimized to control at least one of membrane fouling or membrane scaling.

One exemplary embodiment of a flushing system includes a feed, at least one pump, a first fluid path, and a second fluid path. The feed is configured to dispense fluid, and is in fluid communication with the at least one pump. The first fluid path includes a membrane and is in fluid communication with the at least one pump, while the second fluid path includes a vessel and is in fluid communication with the at least one pump. Additionally, the first fluid path and the second fluid path are configured to be in fluid communication with each other when in a permeate-generating configuration, and configured to be out of fluid communication with each other in a flushing configuration.

The flushing system can further include a controller. The controller can be configured to move the first and second fluid paths between the permeate-generating configuration and the flushing configuration. The system can be configured such that a flow rate of fluid through the second fluid path is greater than a flow rate of the fluid through the first fluid path. In some embodiments, the system can further include a flow divider. The flow divider can be configured to split flow of fluid to each of the first fluid path and the second fluid path.

The first fluid path can further include one or more additional membranes. In some such embodiments, the system can further include a third fluid path having at least one membrane of the one or more additional membranes. Further, the third fluid path can be in fluid communication with the at least one pump. Additionally, the third fluid path can be configured to be in fluid communication with each of the first fluid path and the second fluid path in the permeate-generating configuration, and configured to be out of fluid communication with each of the first fluid path and the second fluid path in the flushing configuration.

In some embodiments, the system can be configured such that the first fluid path and the second fluid path are configured to be flushed substantially simultaneously. A flow rate of fluid flowing through the second fluid path can be approximately in the range of about two times to about ten times greater than a flow rate of fluid flowing through the first fluid path in the flushing configuration. A flow rate of fluid flowing through the first fluid path can be set based on a maximum flow rate tolerated by the membrane. A pressure differential across the membrane can be set based on a maximum pressure differential tolerated by the membrane.

In some embodiments of the system, at least one pump can include a first pump disposed within the first fluid path and a second pump disposed within the second fluid path. In at least some such embodiments, the first pump can be out of fluid communication with the second fluid path and the second pump can be out of fluid communication with the first fluid path. The at least one pump in the flushing configuration can be configured to flow fluid through the first fluid path based on a maximum flow rate tolerated by the membrane. Further, the at least one pump in the flushing configuration can be configured to flow fluid through the second fluid path based on a techno-economically optimal flow rate in the second fluid path.

### BRIEF DESCRIPTION OF THE DRAWINGS

This disclosure will be more fully understood from the following detailed description taken in conjunction with the accompanying drawings, in which:

FIG. 1A is a schematic diagram of a prior art double-acting batch RO system in permeate production mode;

FIG. 1B is a schematic diagram of a prior art permeate production phase of a semi-batch RO system;

FIG. 2A is a schematic diagram of the prior art flush process for the double-acting batch RO system of FIG. 1A;

FIG. 2B is a schematic diagram of the prior art flush process for the semi-batch RO system of FIG. 1B;

FIG. 3A is a schematic diagram of an exemplary embodiment of a layout for flushing of the RO system of FIG. 2A;

FIG. 3B is a schematic diagram of an exemplary embodiment of a layout for flushing of the semi-batch RO system of FIG. 2B;

FIG. 3C is a schematic diagram of another exemplary of a layout for flushing the batch RO system of FIG. 2A that has constant permeate production;

FIG. 3D is a schematic diagram of a system having a pump connected to a flow divider that flushes a plurality of loops;

FIG. 4 is a schematic diagram of an exemplary embodiment of a layout for flushing an RO system having multiple membranes;

FIG. 5A is a schematic diagram of a prior art layout of a batch counterflow RO (batch CFRO) system for permeate production;

FIG. 5B is a schematic diagram of a prior art layout for flushing of the batch CFRO system of FIG. 5A;

FIG. 5C is a schematic diagram of an exemplary embodiment of a layout for flushing the CFRO system of FIG. 5A;

FIG. 5D is a schematic diagram of another exemplary embodiment of a layout for flushing the CFRO system of FIG. 5A;

FIG. 6 is a schematic diagram of an embodiment of a multi-staged system that includes a plurality of tanks; and

FIG. 7 is a schematic diagram of one exemplary embodiment of a computer system upon which the control system of the present disclosures is built.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, compositions, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Like-numbered components across embodiments generally have similar features unless otherwise stated or a person skilled in the art would appreciate differences based on the present disclosure and/or his/her knowledge. Accordingly, aspects and features of every embodiment may not be described with respect to each embodiment, but those aspects and features are applicable to the various embodiments unless statements or understandings are to the contrary.

To the extent that the present disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, a person skilled in the art will recognize various terms that are used herein interchangeably, such as the terms “tubing” and “piping” to refer to the conduits within the system that can be responsible for connecting system components and flowing saline fluid and/or flushing fluid throughout the system. Further, to the extent features, sides, or steps are described as being “first” or “second,” such numerical ordering is generally arbitrary, and thus such numbering can be interchangeable. Still further, in the present disclosure, like-numbered components of various embodiments generally have similar features when those components are of a similar nature and/or serve a similar purpose. Lastly, the present disclosure includes some illustrations and descriptions that include prototypes or bench models. A person skilled in the art will recognize how to rely upon the present disclosure to integrate the techniques, systems, devices, and methods provided for into a product in view of the present disclosures.

At least one novel aspect of the present disclosure lies in minimizing flush time of an RO system by separating the RO system into components that can be flushed in the shortest possible amount of time. For example, in an RO system, a membrane can be decoupled from the rest of the system and flushed separately from the remainder of the system. Flushing can occur by configuring one or more pumps to flow a flushing fluid through separate loops of components that are optimized based on the maximum supported flow rate therethrough. A person skilled in the art will recognize that membranes can support a maximum flow rate therethrough that, if exceeded, can damage the membrane beyond repair or coverage by manufacturer's warranty. The flow rate that is supported through the membrane can thus become a limiting factor, or bottleneck, as flushing the entire system at the maximum flow rate supported by the membrane can be time consuming and inefficient. By flushing the membrane separately from the remainder of the system, different flow rates can be used for flushing each of the components. For example, the flushing of the membrane can be performed in parallel or substantially simultaneously with the flushing of the system to allow the system to be fully flushed at substantially the same time that the membrane is fully flushed. In some embodiments, a pressure differential across the membrane can be set based on a maximum pressure differential tolerated by the membrane.

Reverse osmosis systems to which the methods of the present disclosure can be applied can include any time-variant RO process (semi-batch, pulse-flow) or static RO process (single-stage, two-stage RO) to minimize the time required to flush the system. For example, in batch RO systems, the cycle down-time may be approximately 7% of the whole cycle, resulting in significant water loss (10%). Minimizing flush time greatly reduces two of batch RO's parasitic losses-water loss during the flush/recharge phases due to osmotic backwash and downtime in permeate production. This improves batch RO performance relative to conventional RO. A person skilled in the art will recognize that although separating the membrane from the rest of the system as discussed in the present embodiments can result in more frictional losses, those losses are minor compared to the significant reduction in water losses experienced when the membrane is separated prior to flushing.

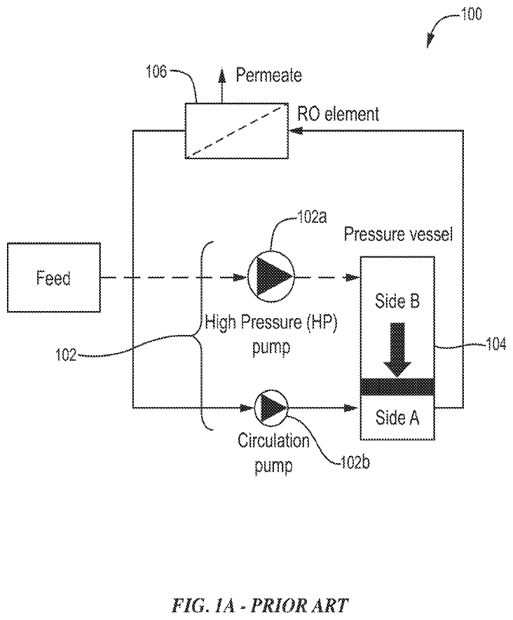

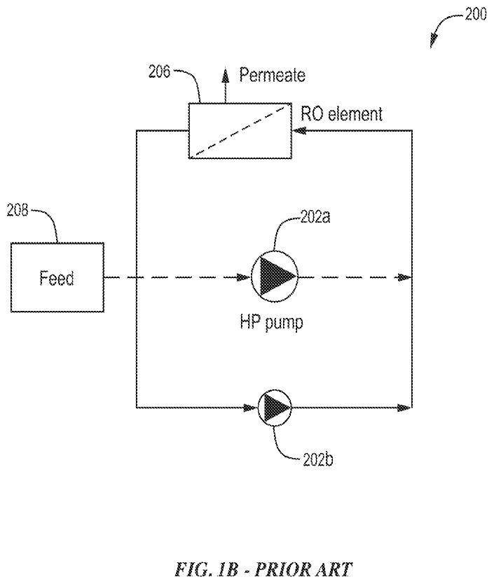

FIG. 1A illustrates a prior art double-acting batch RO system 100 in permeate production mode, e.g. generating freshwater from saline water. The system 100 can include a plurality of pumps 102, a variable volume pressure vessel or a pressure vessel 104 having a collapsing volume (e.g., a piston, a bladder, a tank, or the like), and a membrane 106 for filtering permeate out of the system. The pressure vessel 104, as shown a piston, can include a side A and a side B that can alternate permeate production therebetween. For example, while permeate is being produced from side A, side B is being filled with feed water, e.g., saline water, from a feed vessel 108 in preparation for the next permeate production phase. As shown, the high pressure pump 102a fills up side B, which increases a volume of side B and decreases the volume of side A, thereby pressurizing side A. Fluid from the high pressure pump 102a is separated from the system by the pressure vessel 104. As side B fills up, side A decreases in volume at substantially the same rate, with the contents being forced into the membrane and filtered out of the system 100 as permeate. The circulation pump 102b can pump the contents of side A from the piston to the membrane where the permeate is filtered out of the system and the remainder of the fluid gets recirculated through the system 100, enters the circulation pump 102b and flows into side A.

FIG. 1B illustrates a prior art permeate production phase of a semi-batch RO system 200. As shown, the feed 208 is circulated through the system with the circulation pump 202b pushing the feed through the membrane 206. The permeate, e.g., freshwater, is filtered out of the system and the remainder is recirculated through the system for further desalination. The circulation pump 202b can be used to overcome drag forces and keep the fluid circulating through the system 200. The high pressure pump 202a can apply the pressure required to push the permeate through the membrane 206. The high pressure pump 202b can increase the pressure in the loop to the pressures needed for RO. The high pressure pump 202b in the examples of FIG. 1A and FIG. 1B, therefore, can provide the pressure and the permeate production rate can be determined by the high pressure flow rate. The high pressure pump 202a can introduce feed into the system at a certain rate, and permeate can leave the system at a similar rate.

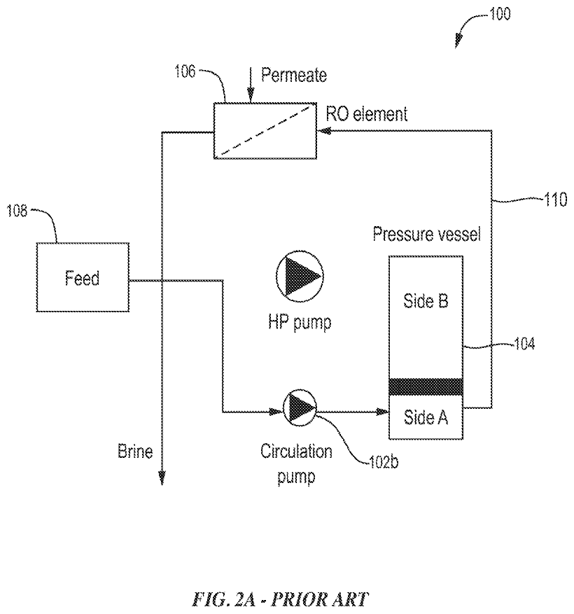

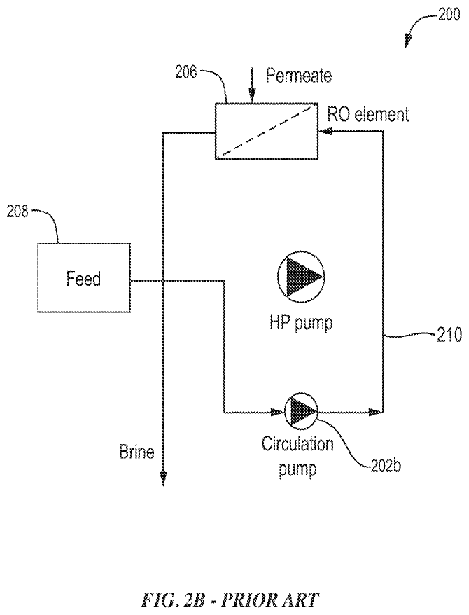

FIGS. 2A and 2B illustrate a prior art flush process for the double-acting batch RO system of FIG. 1A and the semi-batch RO system of FIG. 1B, respectively. The systems are shown at the beginning of the flush phase, with the systems being filled with concentrate or diluate that has accumulated through the permeate production phase. In the flush phase, the system is filled with concentrate and should be cleaned to introduce a fresh feed therein. In some embodiments, the concentrate or diluate can be an aqueous saline solution, or brine, that can buildup and clog parts of the system, which is flushed prior to introducing a fresh feed thereto.

As shown in FIG. 2A, flushing of the conventional system 100 includes pumping a flushing fluid through the circulation pump 102b to clean out the portion of the piston 104 in which permeate production was performed, e.g., side A. As shown, the flushing fluid is pumped towards the membrane 106 to flush the membrane, with concentrate being excreted out of the system. As noted above, an extended flush time is required because the flushing flowrate is limited by the RO membrane element specifications. For example, a maximum flush rate of approximately 70 gallons per minute is pumped during the flush phase to clean out the concentrate from the system due to the maximum allowable flow rate permitted by the membrane 106, which is far below a threshold supported by circulation tubing 110 and the vessel 104. A person skilled in the art will recognize that the membrane 106, or membrane module in some instances, is limited locally by the flow velocity, which at the modular level, can be expressed by a flow rate. Backwash occurs, at least in part, due to regular osmosis when a flushing fluid is pumped through the membrane as the salt content of the permeate is lower than that of the flushing fluid in the membrane, allowing fresh water to reenter the membrane. The longer the flushing occurs, the more water loss is experienced during the flushing phase.

FIG. 2B illustrates a prior art flushing process for the semi-batch RO system 200 shown in FIG. 1B. The reduced flow rate through the membrane 206 leads to water loss due to backwash of the permeate and extended flush times as described above with respect to FIG. 2A.

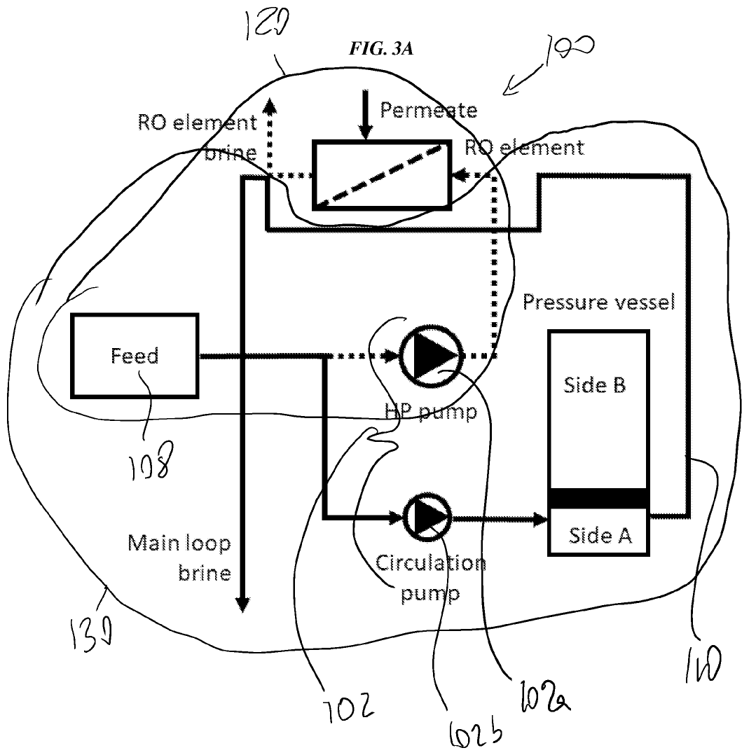

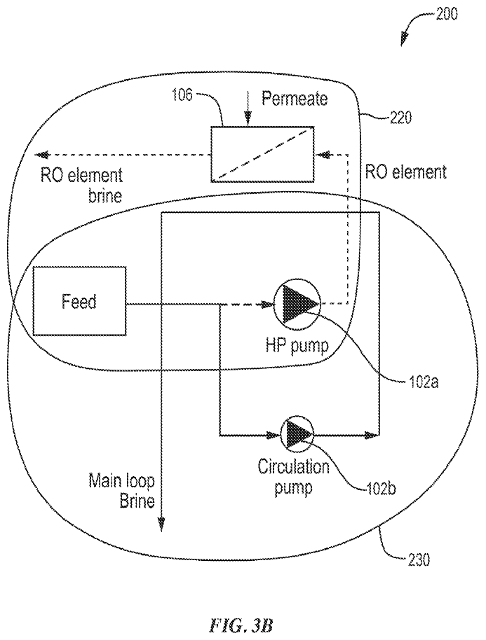

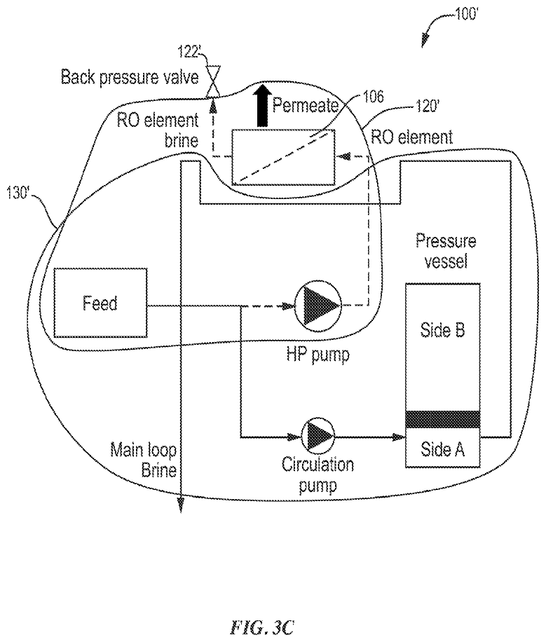

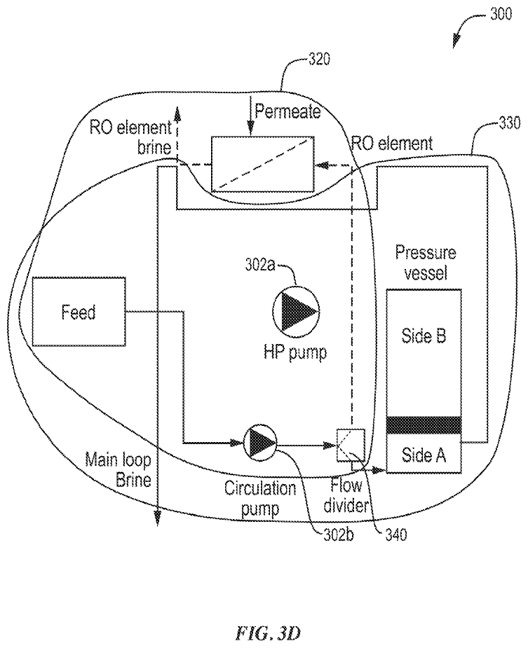

FIG. 3A illustrates an exemplary embodiment of flushing the RO system 100 of FIG. 2A of the present embodiments. For example, the hydraulic circuit of the RO system can be split into two loops for flushing—a first loop 120 for flushing the membrane and a second loop 130 for flushing the remainder of the system 100 (e.g., the vessel 104, the circulation tubing 110, and the like). It will be appreciated that while the term “loop” is used to refer to the flushing of the system, in some embodiments, the fluid is not recycled or run through the system a plurality of times. More generally the term “loop” merely identifies the system 100 being divided out into multiple sub-systems, allowing the sub-systems to be flushed separately. In at least some instances a “loop” can be referred to as a “fluid path.”

As shown, the flushing fluid can be fed into the system through the feed 108 and branched between a plurality of pumps 102. The flushing fluid can typically be a liquid, e.g., a saline liquid, or a liquid solution, though the term fluid is used because it may be possible for the fluid to be a gas. Each pump 102 can be connected to one or more of the first loop 120 or the second loop 130, with a plurality of pumps being connected to a single loop and a pump being connected to a plurality of loops in some embodiments, as discussed in greater detail below. For example, to flush the first loop 120, the high pressure pump 102a can receive a first portion of the flushing fluid and be configured to pump the fluid to the membrane 106, as illustrated by the flow path depicted by dotted lines in FIG. 3A. As shown, the remainder of the system, e.g., the main loop 130, can be separated from the first loop 120 such that the high pressure pump 102a can deliver the flushing fluid directly to the membrane 106, though in some embodiments, one or more additional components of the system 100 can be included to facilitate delivery of the flushing fluid from the pump to the membrane. The flushing fluid can flush the membrane 106 from concentrate, which is excreted from the membrane. Permeate backflows into the system during flushing, as discussed above with respect to FIG. 2A, but the amount of backflow is far smaller as the time taken to flush the membrane is significantly reduced.

In some embodiments, a flow rate of fluid flowing through the second loop 130 can be approximately in the range of about two times to about ten times greater than a flow rate of fluid flowing through the first loop 120 in the flushing configuration. This magnitude of difference in flow rates can be considered a substantial difference such that the flow rate of the fluid through the second fluid path is substantially greater than the flow rate of the fluid through the first fluid path. By way of example, the flow rate of the flushing fluid from the pump to the membrane 106 can be set at approximately a maximum flow rate supported by the membrane specifications, e.g., a DOW SW30-4040 membrane is rated for a maximum flow rate of approximately 57 cm/s, and/r 70 gallons per minute for an 8-inch diameter Dow Seawater RO elements membrane, though flow rates smaller than the maximum flow rate are possible.

The circulation pump 102b can receive a second portion of the flushing fluid from the feed 108 and be configured to pump the fluid through the second loop 130, as illustrated by the flow path depicted by solid lines in FIG. 3A. For example, as shown, the circulation pump 102b can flush the concentrate from side A and the remainder of the tubing 110 of the system. A person skilled in the art will appreciate that the tubing 110 can more generally be appreciated as a path through which fluid flow, and thus does not necessarily require the inclusion of tubes, nor does it imply any particular shape, size, etc. for use in the system 100, or other systems disclosed herein that also reference the use of “tubing.”

The system can be flushed in series or in parallel with the membrane. That is, the membrane can be flushed prior to the remainder of the system or vice versa, or the membrane and the remainder of the system can be flushed at substantially the same time to reduce downtime of the overall system. In some embodiments, the flow rate in the high pressure pump 102a and the circulation pump 102b used for flushing the first 120 and second loops 130 can be optimized such that flushing of the second loop 130 occurs at substantially the same time and/or concludes at substantially the same time as the flushing of the first loop 120. In the event that a drag force on the flushing of the membrane is high, an economically favorable flow rate, or a cost optimal or techno-economically optimal flow rate, can be set for flushing of the first loop 120 such that flushing of the first loop 120 completes before and/or after flushing of the second loop 130 based on the location of the drag force. A person skilled in the art will recognize that substantially simultaneous operation includes the flushing of the first loop and the second loops occurs and/or is being concluded within approximately 0.1 seconds of one another, though in some embodiments, substantially simultaneous operation can include from approximately 0.01 seconds to approximately 5 seconds. In some embodiments, one or more energy recovery devices (ERDs) can be added between the first loop 120 and the second loop 130. The ERDs can be used to decrease energy consumption by recovering energy from the brine and transferring it to the feed stream for use in flushing the system.

FIG. 3B illustrates flushing of the semi-batch RO system 200 of FIG. 2B. As shown, the flushing fluid can branch between the high pressure pump 102a and the circulation pump 102b, with the high pressure pump flushing the membrane 106 of concentrate in a first loop 220, as illustrated by the flow path depicted by dotted lines in FIG. 3B, while the circulation pump flushes the remainder of the system, e.g., the main loop 230, as illustrated by the flow path depicted by solid lines in FIG. 3B.

FIG. 3C illustrates an alternate layout of flushing the batch RO system 100′ of FIG. 2A of the present embodiments having constant permeate production. The membrane 106 can be flushed with fresh feed, under low pressure, which can rapidly re-fill the system with fresh feed water. However, there will still be reverse flux in the system, and permeate will be lost. To combat the permeate loss, the system 100′ can implement one or more back-pressure valve 122′ on a first loop 120′, to set the system up in such a way that flushing of the membrane 106 still occurs under high pressure, and permeate is still being generated. At the same time, the main loop 130′ would not be pressurized, and would be rapidly flushed. That is, the section with the high-pressure pump and the membrane 106 can behave like a continuous RO system, but without any pressure recovery. Such a configuration may not be particularly efficient for long periods of time, due, for example, to a possible lack of pressure recovery, but the system would only be operating in this manner during a shortened flush phase. Thus, benefits can still be realized from such a configuration without significant drawbacks. Once the rest of the system 100′ is flushed, the valves 122′ can be switched back to the batch operation mode position, and the normal batch permeate production phase can begin. In this way, the amount of time that permeate is being lost due to reverse flux can be nearly completely eliminated. While such an operation can increase the operation costs due to the additional cost of the back-pressure regulator and the cost of operating without pressure recovery, in cases where the value of permeate is high, and minimizing reverse flux is important, this configuration may be an improvement.

One or more parameters of the system can be optimized for maximum efficiency of the flush phase. In some embodiments, a flushing pressure can be optimized to regulate backwash through the one or more membranes. For example, the flushing pressure can be optimized such that backwash is substantially eliminated through the membrane 106. Alternatively, or additionally, the flushing pressure can be optimized to continue producing permeate throughout the flush phase. The composition of the flushing fluid can be optimized to regulate backwash or control membrane fouling or scaling, and/or a temperature of the flushing fluid can be optimized to regulate backwash or control membrane fouling or scaling.

Another variation on this configuration can be a system in which the back pressure varies over time. When the flush phase starts, the pressure in the membrane can be high to prevent reverse flux (e.g., approximately in the range of about 70 bar to about 80 bar). However, as time passes and fresh feed is introduced into the system, the back pressure can reduce over time such that by the time the rest of the system has been flushed, the pressure can revert to an initial pressure required during a normal permeate production phase (e.g., approximately in the range of about 30 bar to about 40 bar for seawater feed, lower for brackish feed).

The pressure can be varied over time to achieve different goals, such as maintaining a constant or nearly constant flux, achieving a near zero flux, so that reverse flux is minimized, and/or a number of other goals that would ultimately result in maximizing the profit of the system. A person skilled in the art, in view of the present disclosures, will understand that there are various parameters that can be utilized to help maximize efficiencies and/or profits. In some embodiments, the control of this time-variant system can be used in conjunction with a machine-learning algorithm. This may prove valuable, for example, in instances in which the system is operating with feedwater that has variable conditions over time.

While the high-pressure pump 102a is shown performing the flushing of the membrane 106, it will be appreciated that the circulation pump 102b or another pump can be used to flush one or more of the system 100 and/or the membrane 106. Moreover, one or more of the pumps can be configured to operate under a wide range of pressures and/or flow rates when producing permeate and/or flushing the system. For example, the high pressure pump 102a or the circulation pump 102b can operate under low-flow, high-pressure conditions during the permeate production phase, as shown in FIGS. 1A and 1B, as well as low-pressure, high-flow conditions during the flushing phase, as discussed above.

Moreover, as shown in FIG. 3D, a system 300 can include a flow divider 340 that receives the flushing fluid to flush both a first loop 320 and a second loop 330. In such embodiments, the circulation pump 302b can be rated for the combined flow of both loops, e.g., the pump needs to support low flow rates as needed by the membrane 106 and high flow rates used to flush the remainder of the system. In some embodiments, one or more new pumps can be added to flush either loop.

In embodiments, in which a single pump is used to flush multiple loops, e.g., the circulation pump 302b with the flow divider 340, the circulation pump can be configured to support operation at two acceptable ranges. The flow divider 340 can allow the system 300 to divert at least part of the flow to the first loop 320 and the remainder of the flow through the second loop 330. The flow of flushing fluid through each of the first and second loops 320, 330 can be at the same pressure. Thus, a lower flow rate can be achieved in the membrane 106, and the system can be set up so that both loops flush (at low pressure, e.g., at approximately 1 bar or less) in the same amount of time.

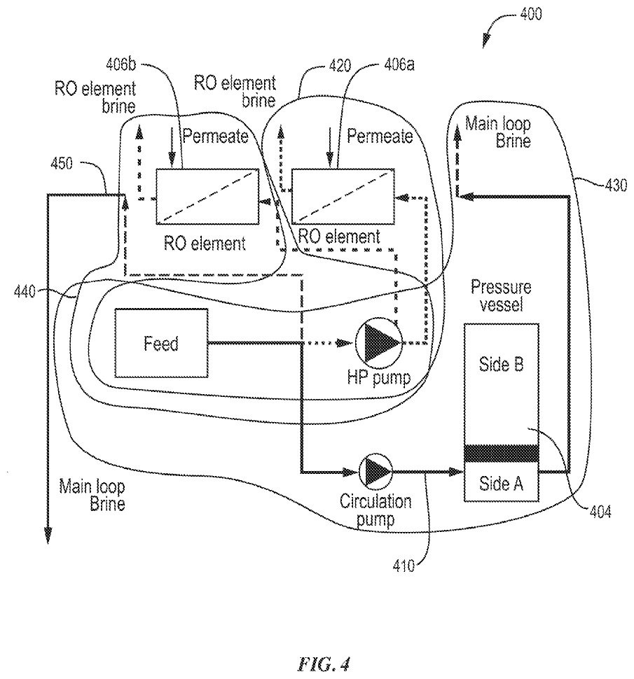

For example, in some embodiments, an RO system 400 can include a plurality of membranes 406a, 406b for creating permeate. One or more of the membranes 406a, 406b can be discrete membrane modules or, in some embodiments, a bundle of hollow fiber membranes. Flushing of the system 400 can include decoupling the system into a plurality of loops 420, 430, 440 such that each membrane 406a, 406b is disposed in its own loop. FIG. 4 illustrates an exemplary embodiment of flushing such an RO system having multiple membranes. As shown, the flushing system can include three loops-a first loop 420 for flushing the concentrate out of a first membrane 406a, a second loop 430 for flushing concentrate out of the vessel 404 and circulation tubing of the main loop, and a third loop 440 for flushing concentrate out of a second membrane 406b. The first and third loops 420, 440 can be decoupled from the main loop 430, as well as one another, to minimize flush times in each loop in accordance with the present disclosure. In such embodiments, and in other embodiments of the present system, the second loop 430 and/or loops without membranes can have a greater volume than loops having membranes therein, e.g., the first loop 420 and/or the third loop 440. Alternatively, the first and third loops 420, 440 can be flushed as part of the same loop.

In some embodiments, the main loop 430 can become the limiting factor even in the absence of a membrane therein. For example, the main loop can be a limiting factor if the high flowrates would lead to excessive energy consumption due to increased pressure drop and/or if the main loop has a substantially larger volume. In such embodiments, the main loop 430 can be decoupled and flushed in parallel with the remainder of the system. For example, the main loop can be split into two loops 430, 450 that would allow for the same rapid flushing but with lower flowrates through both sections of the main loops, as shown. In some embodiments, an additional pump (not shown) can be connected to each portion of the main loop to further accelerate the flushing process of each section of the main loop. One or more of the membranes 406a, 406b can also be decoupled by further splitting up its components. For example, the first loop 420 or the third loop 440 can be decoupled by separating a plurality of membranes from the first or third loop and/or separating a circulation tubing 410 of the first or third loops 420, 440 into smaller loops, one having the membrane and another having circulation tubing. Further decoupling of each loop into smaller loops can be performed until it is no longer practical to further reduce the flush time.

A person skilled in the art will recognize that while the present embodiments are discussed with respect to batch RO and semi-batch RO systems, the presently disclosed systems and methods can be applied to any time-variant osmotic mass transfer process such as forward osmosis, low-salt rejection reverse osmosis (LSRRO), counterflow reverse osmosis, or batch osmotically assisted RO, and more broadly to electrodialysis, monovalent-selective electrodialysis, and/or nanofiltration processes operated in a batch mode, as well as flushing any membrane-based system or a system that contains a membrane, a filter, or another component that creates a bottleneck during flushing.

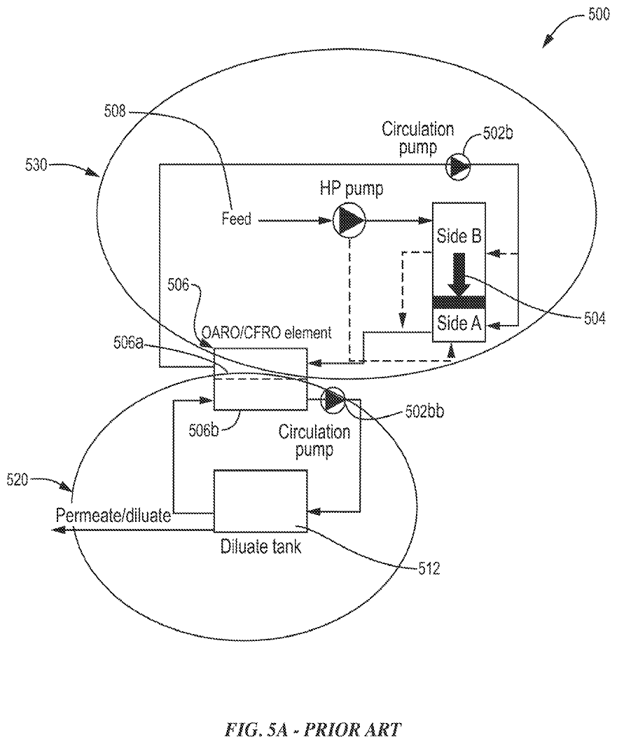

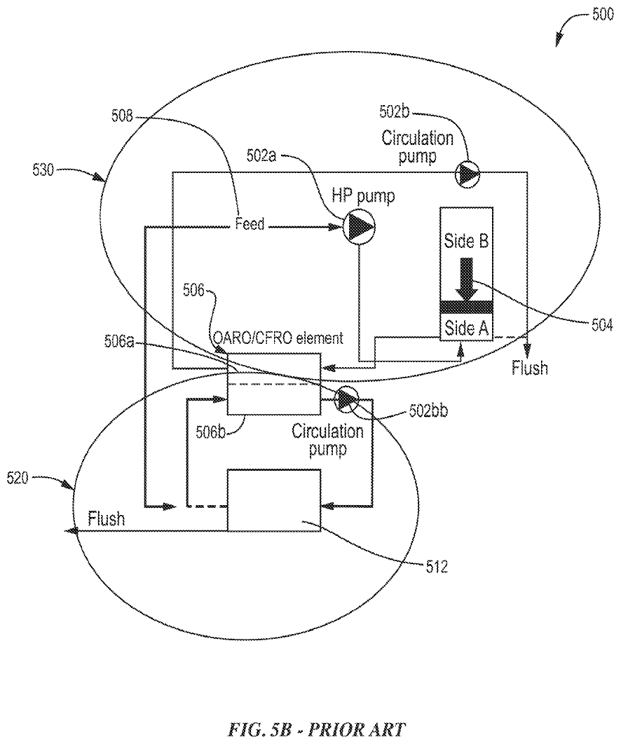

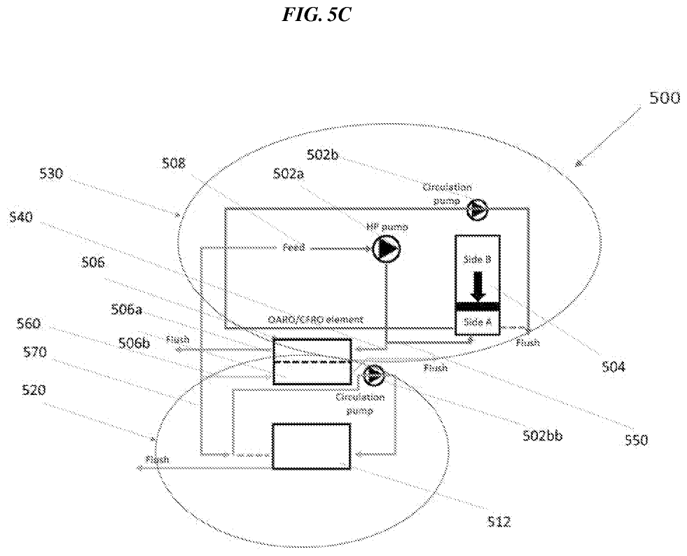

FIG. 5A illustrates a prior art exemplary embodiment of a batch counterflow RO (batch CFRO) system 500 for permeate production. Batch CFRO (also can be referred to as batch osmotically assisted reverse osmosis (OARO) or a number of other names based on the number of names in the literature), is a time-variant system used to turn a contaminated or saline stream into a more concentrated and a less concentrated stream (referred to here as a concentrate and a diluate). In the batch CFRO system, a feed 508 fills side B of the vessel 504 to exert a pressure on side A, which reduces the volume of side A. The pressure exerted by side B exerts a pressure on side A, which releases permeate contained within side A towards the membrane 506, e.g., the counterflow reverse osmosis element (CFRO element). It will be appreciated that the pressure exerted can, in at least some embodiments, be limited by a pressure tolerance of the vessel 504.

The membrane 506 can be similar, but not necessarily the same, as those used in reverse osmosis. Often compositions can include polyamide thin film composite or cellulose triacetate. Membranes can be used, for example, in a flat sheet, plate and frame, spiral-wound form factor, and/or a hollow fiber form factor, which can facilitate the flow of fluid in two opposite directions. As shown, the CFRO element has two portions, with the first portion 506a being exposed to a top loop 530 and the second portion being exposed to a bottom loop 520 (the terms “top” and “bottom” being used for illustrative purposes and by no means limiting as to how the system 500 is set-up). The permeate is filtered through the membrane 506 while fluid of high salinity is fed into the system 500 and repeatedly circulated by a circulation pump 502b of the top loop through side A and the membrane 506. The permeate is fed to a second circulation pump 502bb and circulated through a diluate tank 512 and the second portion 506b of the membrane to filter out salt content. Repeated circulation of the fluid through the first portion 506a of the membrane in the top loop 530 creates a salinity gradient in the CFRO element between the first and second portions 506a, 506b, in which the top loop 530 has a high salt concentration while the bottom loop 520 is predominantly permeate, with the permeate/diluate being released from the diluate tank 512.

FIG. 5B illustrates a prior art flushing of the counterflow RO system 500 of FIG. 5A. As shown, flushing fluid from the feed enters the high pressure pump 502a that is pumped into side A and flows through the membrane 506, out to the circulation pump 502b, and is flushed out of the system. A portion of the flushing fluid is fed to the bottom loop 520 from the feed, with additional flushing fluid crossing from the first portion 506a to the second portion 506b of the membrane, circulating through the second portion 506b of the membrane and the diluate tank 512 by the second circulation pump 502bb, and is flushed out of the system. As in the embodiments of FIGS. 2B and 3B, the membrane 506 serves as a bottleneck of the flushing process, resulting in extended downtimes and permeate loss within the system.

FIG. 5C illustrates an exemplary embodiment of flushing the counterflow RO system 500 of FIG. 5A of the present embodiments. As shown, flushing the counterflow RO system can include splitting the flushing fluid that exits the high pressure pump 502 within the top loop 530 from the feed into separate branches. In the illustrated embodiment, a first branch 540 flows through the first portion 506a of the membrane to flush the concentrate out of the system, while a second branch 550 flows to side A of the vessel 504 to flush the vessel, flows out to the circulation pump 502b, and is flushed out of the system. The feed 508 separately flows fluid toward the bottom loop 520 where the flushing fluid can be split into third and fourth branches. As shown, a third branch 560 flows through the second portion 506b of the membrane and flushes the concentrate out of the membrane, while a fourth branch 570 flows through the circulation pump 502b, is pumped into the diluate tank 512, and is released from the system 500. It will be appreciated that the techniques discussed with respect to the present embodiment can also be applied to the batch RO and semi-batch RO flushing techniques discussed with respect to the above embodiments.

FIG. 5D illustrates an alternate embodiment of flushing the counterflow RO system 500′ of FIG. 5A. As shown, one or more back pressure valves 522′ can be installed on a top loop 530′, which can cause the high pressure side of the membrane 506 to remain at a high pressure, even with separate flush streams in the top loop 530′ and a bottom loop 520′, and even when the membrane 506 is drawing in fresh feed during the flush phase. This can allow for permeate to be generated even as new feed water is flushed through the system, resulting in a system with nearly zero reverse flux, again with the purpose of reducing down time.

As shown above, CFRO systems can produce two outputs: a concentrated stream and a diluted stream. In some embodiments, one or more of the concentrated stream or the diluted stream can be used as the feed stream in a second “stage.” Examples of multi-staged continuous systems can include split-feed CFRO, concentrate-splitting CFRO, OARO, or counterflow osmotically mediated reverse osmosis (COMRO), among others. It will be appreciated that in an OARO system, the concentrate can be the stream that produces water and/or minerals, which can result in the brine being a diluate stream of the OARO system.

The reason for multi-staging can be that there is a maximum recovery ratio (or maximum high and low concentration) that can be reached in a system due to membrane pressure limitations and the feedwater concentration entering the system. By adding additional stages, either higher or lower salinities can be reached than can be reached in a single stage. In batch systems, instead of adding additional stages in physical space, additional “stages” can be added in time, by changing the feed water quality from one batch to the next, thereby allowing higher or lower salinities to be reached in time.

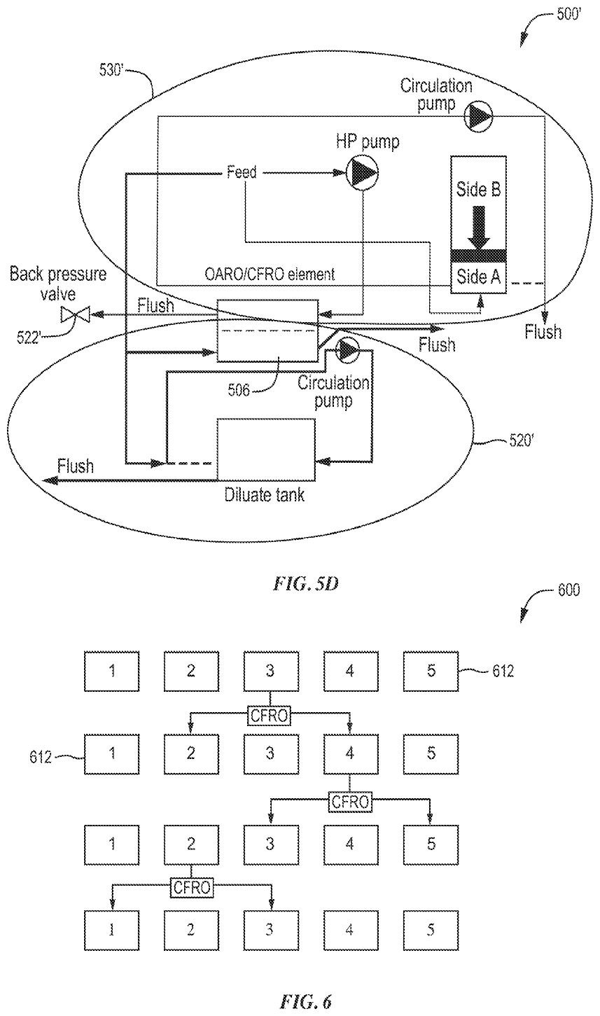

FIG. 6 illustrates an exemplary embodiment of a multi-staged system 600 that includes a number of tanks 612 (at least two). The entire system 600 can be mobilized by using tanker trucks and a mobile CFRO system, which can be mounted, by way of examples on a skid or containerized. The tanks 612 can include varying concentrations therein, as shown, with tanks labeled as “1” being the fluid with the lowest concentration, and those labeled as “5” being the fluid with the highest concentration. Each tank 612 can contain fluid at one concentration, which can minimize energy losses due to mixing of fluids. Feed water, of either one or two different salinities, can enter the batch CFRO system at “3,” and can, in time, split into a concentrated and a diluted stream (e.g., at concentrations “4” and “2”). At least one of these streams can then be flushed out of the system and into a tank or tanker truck, and replaced with new feed water. This can result in feed water at concentration “3,” and tanks at concentrations “2” and “4.” Fluid of concentration “4” can be fed back into the system as the feed, and after another batch CFRO cycle is performed, can be split into concentrations “3” and “5.” The fluid “3” can be fed back into the system as feedwater, while the fluid “5” can be put into another tank or used for another purpose. Any number of tanks and configurations can be used in this system, which can be set up to produce nearly any final salinities.

Mobilizing the system 600 by using mobile tanks, such as tanker trucks, and a mobile CFRO system may be useful when the system only needs to operate for a short period of time, such as weeks or months, rather than years at a time. Non-limiting examples include treating waste from oil and gas operations on site, to reduce the cost of shipping waste water and the volume of waste that would need to be stored in underground wells. A similar system can be used to treat chemical spills, and/or to produce water for disaster-affected areas.

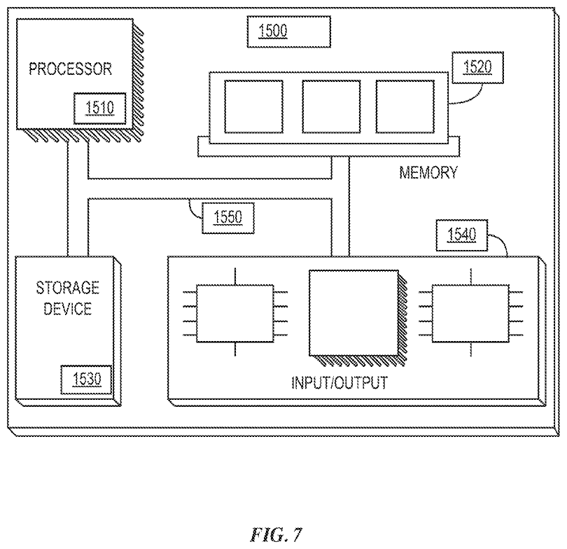

In some embodiments, the system 300 can be coupled and/or otherwise associated with a controller configured to move the first and second fluid paths between a permeate-generating configuration and a flushing configuration, such configurations being understood in view of the present disclosures. FIG. 7 is a block diagram of one exemplary embodiment of a computer system 1500 upon which the controller or control system of the present disclosures can be built, performed, trained, etc. For example, any modules or systems can be examples of the system 1500 described herein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, starting and stopping flow of fluid, control of fluid paths and system configurations that can be automatic, in response to various parameters, and/or manually controlled by a user, including in response to signals/parameters/etc., and so forth, and/or based on observation/preference, and so forth, among other features described in conjunction with the present disclosure. The controller 1500 can optimize operation in response to varying feedwater conditions, varying water demand, varying power pricing, and other factors that can relate to the energy efficiency, reliability, maintenance, or levelized cost of freshwater. In some instances, the controller 1500 can optimize operation in response to stored and/or desired flush times, permeate salinity, and/or operating pressures. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to fluid paths and system components, such as when and/or in response to what conditions the permeate-generating configuration and the flushing configuration should be implemented and/or different configurations for the various loops permitted by the system, storing the flush times, permeate salinity, and/or operating pressures, among other information, which can allow for a machine learning optimization of the system.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a fluid filtration system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

Examples of the above-described embodiments can include the following:

1. A method of flushing a system, comprising:
decoupling one or more membranes from a circulation system;
coupling the one or more membranes to a pump configured to deliver one or more fluids therefrom to form a first fluid path;
pumping fluid through the first fluid path to release concentrate formed in at least one of the one or more membranes or one or more components of the circulation system having the one or more membranes coupled thereto; and
pumping fluid through a second fluid path of the circulation system to release concentrate formed therein, the second fluid path not including the one or more membranes of the first fluid path.

2. The method of claim 1, wherein the pumping fluid through the first path and the pumping fluid through the second path occurs substantially simultaneously.

3. The method of claim 1 or claim 2, further comprising optimizing a flow rate for pumping fluid through the second path such that pumping fluid through the first path and pumping fluid through the second path occurs at substantially the same time.

4. The method of claim 3, wherein the flow rate of fluid when pumping fluid through the second path is greater than a flow rate of fluid when pumping fluid through the first path.

5. The method of claim 3 or claim 4, wherein the flow rate of fluid when pumping fluid through the second path is at least approximately in the range of about two times to about ten times greater than the flow rate of fluid when pumping fluid through the first path.

6. The method of any of claims 1 to 5, wherein the pumping fluid through the second path and the pumping fluid through the first path concludes at substantially the same time.

7. The method of any of claims 1 to 6, further comprising:
decoupling a first portion of the circulation system from the circulation system such that the second fluid path comprises a first fluid sub-path and a second fluid sub-path,
wherein pumping fluid through the second fluid path further comprises:
   pumping fluid through the first fluid sub-path; and
   pumping fluid through the second fluid sub-path.

8. The method of any of claims 1 to 7, further comprising:
decoupling a first membrane from the one or more membranes such that the first fluid path comprises a first membrane fluid sub-path and a second membrane fluid sub-path,
wherein pumping fluid through the first fluid path further comprises:
   pumping fluid through the first membrane fluid sub-path; and
   pumping fluid through the second membrane fluid sub-path.

9. The method of any of claims 1 to 8, wherein the first fluid path and the second fluid path flow through common circulation tubing prior to branching into the first fluid path and the second fluid path.

10. The method of any of claims 1 to 9, in which a flushing pressure is optimized to regulate backwash through the one or more membranes.

11. The method of any of claims 1 to 10, in which a flushing pressure is varied when performing at least one of the actions of pumping fluid through the first fluid path to release concentrate or pumping fluid through the second fluid path to release concentrate.

12. The method of any of claims 1 to 11, in which a flushing pressure is optimized such that backwash is substantially eliminated through the one or more membranes.

13. The method of any of claims 1 to 12, in which a flushing pressure is optimized to continue producing permeate throughout at least one of the actions of pumping fluid through the first fluid path to release concentrate or pumping fluid through the second fluid path to release concentrate.

14. The method of any of claims 1 to 13, in which a composition of the fluid is optimized to regulate backwash.

15. The method of any of claims 1 to 14, in which a composition of the fluid is optimized to control at least one of membrane fouling or membrane scaling.

16. The method of any of claims 1 to 15, in which a temperature of the fluid is optimized to at least one of regulate backwash, control membrane fouling, or control membrane scaling.

17. A flushing system, comprising:
a feed configured to dispense fluid;
at least one pump in fluid communication with the feed;
a first fluid path including a membrane, the first fluid path being in fluid communication with the at least one pump; and
a second fluid path including a vessel, the second fluid path being in fluid communication with the at least one pump,
wherein the first fluid path and the second fluid path are configured to be in fluid communication with each other when in a permeate-generating configuration, and configured to be out of fluid communication with each other in a flushing configuration.

18. The system of claim 17, further comprising a controller configured to move the first and second fluid paths between the permeate-generating configuration and the flushing configuration.

19. The system of claim 17 or 18, wherein the system is configured such that a flow rate of fluid through the second fluid path is greater than a flow rate of the fluid through the first fluid path.

20. The system of any of claims 17 to 19, further comprising:
a flow divider configured to split flow of fluid to each of the first fluid path and the second fluid path.

21. The system of any of claims 17 to 20, wherein the first fluid path further comprises one or more additional membranes.

22. The system of claim 21, further comprising:
a third fluid path that includes at least one membrane of the one or more additional membranes, the third fluid path being in fluid communication with the at least one pump,
wherein the third fluid path is configured to be in fluid communication with each of the first fluid path and the second fluid path in the permeate-generating configuration, and configured to be out of fluid communication with each of the first fluid path and the second fluid path in the flushing configuration.

23. The system of any of claims 17 to 22, wherein the system is configured such that the first fluid path and the second fluid path are configured to be flushed substantially simultaneously.

24. The system of any of claims 17 to 23, wherein the system is configured such that a flow rate of fluid flowing through the second fluid path is approximately in the range of about two times to about ten times greater than a flow rate of fluid flowing through the first fluid path in the flushing configuration.

25. The system of any of claims 17 to 24, wherein the system is configured such that a flow rate of fluid flowing through the first fluid path is set based on a maximum flow rate tolerated by the membrane.

26. The system of any of claims 17 to 25, wherein the system is configured such that a pressure differential across the membrane is set based on a maximum pressure differential tolerated by the membrane.

27. The system of any of claims 17 to 26, wherein the at least one pump includes a first pump disposed within the first fluid path and a second pump disposed within the second fluid path, the first pump being out of fluid communication with the second fluid path and the second pump being out of fluid communication with the first fluid path.

28. The system of any of claims 17 to 27, wherein the at least one pump in the flushing configuration is configured to flow fluid through the first fluid path based on a maximum flow rate tolerated by the membrane, and configured to flow fluid through the second fluid path based on a techno-economically optimal flow rate in the second fluid path.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

Some non-limiting claims that are supported by the contents of the present disclosure are provided below.

What is claimed is:

1. A method of flushing a system, comprising:
decoupling one or more membranes from a circulation system;
coupling the one or more membranes to a pump configured to deliver one or more fluids therefrom to form a first fluid path;
pumping fluid through the first fluid path to release concentrate formed in at least one of the one or more membranes or one or more components of the circulation system having the one or more membranes coupled thereto; and
pumping fluid through a second fluid path of the circulation system to release concentrate formed therein, the second fluid path not including the one or more membranes of the first fluid path.

2. The method of claim 1, wherein the pumping fluid through the first path and the pumping fluid through the second path occurs substantially simultaneously.

3. The method of claim 1, further comprising optimizing a flow rate for pumping fluid through the second path such that pumping fluid through the first path and pumping fluid through the second path occurs at substantially the same time.

4. The method of claim 3, wherein the flow rate of fluid when pumping fluid through the second path is greater than a flow rate of fluid when pumping fluid through the first path.

5. The method of claim 1, further comprising:
decoupling a first portion of the circulation system from the circulation system such that the second fluid path comprises a first fluid sub-path and a second fluid sub-path,
wherein pumping fluid through the second fluid path further comprises:
pumping fluid through the first fluid sub-path; and
pumping fluid through the second fluid sub-path.

6. The method of claim 1, further comprising:
decoupling a first membrane from the one or more membranes such that the first fluid path comprises a first membrane fluid sub-path and a second membrane fluid sub-path,
wherein pumping fluid through the first fluid path further comprises:
pumping fluid through the first membrane fluid sub-path; and
pumping fluid through the second membrane fluid sub-path.

7. The method of claim 1, wherein the first fluid path and the second fluid path flow through common circulation tubing prior to branching into the first fluid path and the second fluid path.

8. The method of claim 1, in which a flushing pressure is optimized to regulate backwash through the one or more membranes.

9. The method of claim 1, in which a flushing pressure is varied when performing at least one of the actions of pumping fluid through the first fluid path to release concentrate or pumping fluid through the second fluid path to release concentrate.

10. The method of claim 1, in which a flushing pressure is optimized such that backwash is substantially eliminated through the one or more membranes.

11. The method of claim 1, in which a flushing pressure is optimized to continue producing permeate throughout at least one of the actions of pumping fluid through the first fluid path to release concentrate or pumping fluid through the second fluid path to release concentrate.

12. A flushing system, comprising:
a feed configured to dispense fluid;
at least one pump in fluid communication with the feed;
a first fluid path including a membrane, the first fluid path being in fluid communication with the at least one pump; and
a second fluid path including a vessel, the second fluid path being in fluid communication with the at least one pump,
wherein the first fluid path and the second fluid path are configured to be in fluid communication with each other when in a permeate-generating configuration, and configured to be out of fluid communication with each other in a flushing configuration.

13. The system of claim 12, further comprising a controller configured to move the first and second fluid paths between the permeate-generating configuration and the flushing configuration.

14. The system of claim 12, wherein the system is configured such that a flow rate of fluid through the second fluid path is greater than a flow rate of the fluid through the first fluid path.

15. The system of claim 12, further comprising:
a flow divider configured to split flow of fluid to each of the first fluid path and the second fluid path.

16. The system of claim 12, wherein the first fluid path further comprises one or more additional membranes.

17. The system of claim 16, further comprising:
a third fluid path that includes at least one membrane of the one or more additional membranes, the third fluid path being in fluid communication with the at least one pump,
wherein the third fluid path is configured to be in fluid communication with each of the first fluid path and the second fluid path in the permeate-generating configuration, and configured to be out of fluid communication with each of the first fluid path and the second fluid path in the flushing configuration.

18. The system of claim 12, wherein the system is configured such that a flow rate of fluid flowing through the second fluid path is approximately in the range of about two times to about ten times greater than a flow rate of fluid flowing through the first fluid path in the flushing configuration.

19. The system of claim 12, wherein the at least one pump includes a first pump disposed within the first fluid path and a second pump disposed within the second fluid path, the first pump being out of fluid communication with the second fluid path and the second pump being out of fluid communication with the first fluid path.

20. The system of claim 12, wherein the at least one pump in the flushing configuration is configured to flow fluid through the first fluid path based on a maximum flow rate tolerated by the membrane, and configured to flow fluid through the second fluid path based on a techno-economically optimal flow rate in the second fluid path.
